(19) United States
(12) Patent Application Publication
(10) Pub. No.: US 2026/0296811 A1
(43) Pub. Date: Oct. 1, 2026

(54) Rotating Grain Spreader for Uniform Distribution in Storage Silos

(71) Applicant: Kevin M. Curry, Wilmington, OH (US)

(72) Inventor: Kevin M. Curry, Wilmington, OH (US)

(21) Appl. No.: 19/090,305

(22) Filed: Mar. 25, 2025

(51) Int. Cl. B65G 69/04

(52) U.S. Cl. CPC B65G 69/0458

(57) ABSTRACT

A rotating grain spreader assembly for use in storage silos is disclosed, designed to achieve uniform grain distribution by utilizing a fully rotating grain distribution assembly. The spreader includes a central support structure, a rotational support mechanism, and a rotating grain distribution assembly. The rotational support mechanism is configured as either an array of rollers arranged circumferentially around the central support structure or a slewing bearing with an inner race fixed to the support structure and an outer race connected to the rotating grain distribution assembly. Incoming grain is directed into a hopper and dispersed outward through strategically positioned vanes as the assembly rotates. The rotation can be achieved through passive means, utilizing grain flow momentum, or through an active drive mechanism such as an electric motor, hydraulic actuator, or mechanical drive system. Optional features include adjustable deflectors, real-time monitoring sensors, and predictive maintenance systems.

### BACKGROUND OF THE INVENTION

### Field of Invention

The present invention relates to grain handling and storage equipment, specifically to grain spreaders used in storage silos. More particularly, the invention pertains to a grain spreader assembly that utilizes a rotating central structure to achieve uniform grain distribution within a silo. The rotation mechanism may employ an array of rollers or a slewing bearing to facilitate smooth and consistent motion.

### BRIEF SUMMARY OF THE INVENTION

The present invention provides a rotating grain spreader designed for use in storage silos to ensure even distribution of grain. Unlike conventional stationary or oscillating spreaders, this invention features a fully rotating assembly that disperses grain uniformly across the silo floor, reducing grain segregation and promoting optimal storage conditions.

The central rotating structure is supported by either an array of rollers or a slewing bearing, allowing smooth and controlled movement. Grain is directed into the spreader, which utilizes its rotational motion to distribute the material in a circular pattern, improving overall fill consistency. The design enhances efficiency in grain storage, minimizes manual intervention, and reduces the risk of spoilage due to uneven piling.

### BRIEF DESCRIPTION OF THE FIGURES

FIG. 1: The rotating grain spreader system operates by receiving incoming grain (FIG. 1.101), directing it into a hopper (FIG. 1.103), channeling it through dispersal vanes (FIG. 1.105), engaging a rotational mechanism (FIG. 1.107), evenly distributing the grain across the silo floor (FIG. 1.109), monitoring distribution parameters (FIG. 1.111), and resetting for continuous operation (FIG. 1.113).

FIG. 2 provides top-down and top-down profile views of the rotating grain spreader assembly, illustrating the central support structure (102), rotating grain distribution assembly (104), rotational support mechanism (106), dispersal vanes (108), and inclined chute (110), emphasizing the radial layout of components and the integration of the rotation system.

FIG. 3 provides profile and side views of the rotating grain spreader assembly, illustrating the central support structure (102), rotating grain distribution assembly (104), rotational support mechanism (106), dispersal vanes (108), and inclined chute (110), focusing on vertical alignment, grain flow path, and the interaction between moving and stationary components.

### DETAILED DESCRIPTION

The present invention relates to a grain spreader assembly designed for use in agricultural storage silos, wherein the entire assembly is capable of rotational motion to facilitate uniform grain distribution. Unlike conventional stationary or oscillating spreaders, the invention incorporates a fully rotating structure that disperses grain in a controlled and even manner throughout the silo, thereby reducing issues associated with grain segregation and uneven piling. The rotating assembly is supported either by an array of rollers or by a slewing bearing, each of which provides smooth and controlled rotation while accommodating the dynamic loading conditions associated with grain distribution.

The grain spreader assembly consists of a central support structure that houses the rotational mechanism and a grain distribution assembly that disperses the incoming grain. The central support structure is configured to be mounted at the top of the silo, positioned to receive grain from an incoming conveyor, auger, or chute. The incoming grain is funneled into a distribution hopper, which directs the material toward a series of dispersal channels or vanes. These vanes are strategically positioned and angled to guide the grain outward from the center of the spreader, ensuring an even distribution pattern as the assembly rotates.

The rotation of the grain spreader is facilitated by one of two primary support mechanisms: an array of rollers positioned circumferentially around the central structure or a single large slewing bearing. In the roller-based configuration, multiple load-bearing rollers are arranged in a circular pattern around the perimeter of the rotating structure. Each roller is mounted on a fixed support bracket and is constructed from a high-durability material such as hardened steel or a polymer composite to withstand prolonged exposure to dust and grain particles. The rollers engage with a circular track or raceway integrated into the rotating assembly, allowing it to move with minimal friction. The use of multiple rollers distributes the load effectively, preventing localized stress concentrations and ensuring smooth operation.

In an alternative configuration, the rotating assembly is supported by a single large slewing bearing. The slewing bearing consists of an inner race and an outer race, with a series of rolling elements positioned between them to facilitate low-friction rotation. The inner race is fixed to the stationary support structure, while the outer race is connected to the rotating grain distribution assembly. The slewing bearing provides enhanced load-bearing capacity and a more compact design compared to the roller-based system, making it particularly suitable for larger grain spreader installations where higher rotational stability is required.

The rotation of the grain spreader can be achieved through either passive or active means. In a passive configuration, the force of the incoming grain provides the necessary momentum to initiate and sustain rotational motion. This approach relies on the asymmetrical deflection of grain within the dispersal vanes to generate torque, gradually spinning the assembly as more material flows through. Alternatively, an active drive mechanism can be employed to control the rotation. This may include an electric motor, hydraulic actuator, or other mechanical drive system coupled to the rotating structure via a geared interface or direct drive connection. An actively driven system allows for precise control of rotation speed, ensuring optimal grain dispersion even under varying flow conditions.

To accommodate different silo sizes and grain flow rates, the spreader assembly can be manufactured in multiple sizes and configurations. Adjustable vanes or deflectors may be incorporated to fine-tune the dispersal pattern, optimizing the spreader's performance for different types of grain, including corn, wheat, soybeans, and other bulk commodities. Additionally, the spreader's structural components can be fabricated from corrosion-resistant materials such as galvanized steel, stainless steel, or powder-coated aluminum to enhance durability in harsh agricultural environments.

The design of the rotating grain spreader offers several advantages over conventional stationary and oscillating spreaders. By ensuring a more uniform grain distribution, the invention minimizes the formation of conical piles and uneven loading patterns, which can lead to spoilage, compaction issues, and inefficient space utilization within the silo. The rotating mechanism also reduces the need for manual intervention to level the stored grain, decreasing labor costs and improving overall operational efficiency. Furthermore, the ability to incorporate either a roller-based support system or a slewing bearing provides flexibility in manufacturing and installation, allowing the system to be adapted to a wide range of storage applications.

The grain spreader can be integrated with automated monitoring systems to further enhance its functionality. Sensors may be installed to measure rotation speed, grain flow rate, and distribution uniformity, with data transmitted to a central control unit for real-time analysis. If an active drive mechanism is used, the control system can adjust the rotational speed based on the detected flow characteristics, ensuring optimal performance under varying operational conditions. Additionally, predictive maintenance algorithms can be employed to monitor wear on rollers or bearings, alerting operators when servicing or replacement is required.

In some embodiments, the rotational speed of the grain spreader assembly may range between 10 and 40 RPM, depending on the flow rate, bin size, and grain type. This speed range ensures optimal grain dispersion while minimizing excessive force that could cause unintended segregation of particles. The motor driving the rotation may be configured to operate within this range, either through direct speed control or by adjusting gear ratios.

Additionally, the rotating chute may be equipped with trap doors or splash boards to further refine the distribution pattern of the grain. These components can be manually or automatically adjusted to modify the spread radius and improve coverage for different grain types and storage conditions. The trap doors may be positioned at key points along the chute to create additional breakpoints in the grain flow, while splash boards help deflect grain more evenly across the bin.

Furthermore, the rotating assembly may incorporate wear-resistant linings such as urethane, ceramic, or other abrasion-resistant materials to extend the lifespan of components exposed to high-velocity grain flow. These linings reduce material wear and ensure consistent performance, particularly when handling abrasive grains like rice. The modular nature of the spreader allows for easy replacement or customization of these protective linings based on operational needs.

Overall, the present invention provides an innovative solution for improving grain distribution within storage silos through the use of a fully rotating grain spreader assembly. By employing a roller-supported or slewing bearing-supported rotating structure, the invention ensures smooth, controlled motion that enhances grain storage efficiency, reduces waste, and extends the operational lifespan of the silo system. The modular design and adaptability to various drive mechanisms make the invention suitable for a wide range of agricultural and industrial grain storage applications, offering a significant improvement over existing grain spreading technologies.

### DETAILED DESCRIPTION OF FIGURES

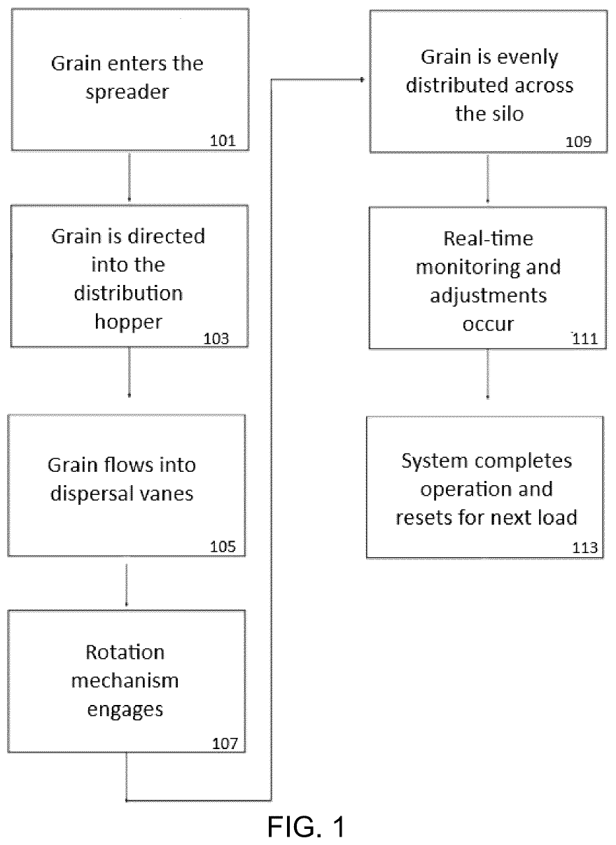

### FIG. 1.101—Grain Enters the Spreader

As grain is transported into the storage silo via an auger, conveyor, or chute, it is directed toward the inlet of the rotating grain spreader assembly. The incoming grain flow rate varies based on the silo's loading system and can be regulated to ensure consistent distribution. The entry point is positioned centrally above the spreader to allow optimal feeding into the system.

### FIG. 1.103—Grain is Directed into the Distribution Hopper

The grain flows into a distribution hopper, which is designed to receive the material and channel it toward the dispersal system. The hopper is shaped to prevent clogging and ensure a steady, controlled release of grain. Its internal surfaces may be coated with a low-friction material to reduce grain buildup and improve flow efficiency.

### FIG. 1.105—Grain Flows into Dispersal Vanes

From the hopper, the grain is directed into a series of dispersal vanes, which are positioned at calculated angles to guide the material outward from the center of the rotating assembly. The vanes may be fixed or adjustable, allowing customization of the grain distribution pattern based on silo size and grain type. The number and curvature of the vanes determine the spread radius and uniformity.

### FIG. 1.107—Rotation Mechanism Engages

The rotation mechanism, either a roller-supported system or a slewing bearing, initiates movement of the entire grain distribution assembly. If a passive system is used, the force of the grain flow induces rotational motion. In an active system, an electric motor, hydraulic actuator, or mechanical drive engages to regulate rotation speed. The mechanism ensures smooth and controlled motion to optimize grain spread.

### FIG. 1.109—Grain is Evenly Distributed across the Silo

As the spreader rotates, grain exits the dispersal vanes and is projected outward in a circular pattern. The combination of rotation speed, vane angle, and grain flow rate ensures even distribution across the silo floor, minimizing conical piles and reducing segregation. This uniform spreading promotes better aeration, storage efficiency, and grain quality preservation.

### FIG. 1.111—Real-Time Monitoring and Adjustments Occur

Sensors integrated into the spreader assembly track parameters such as rotation speed, grain flow rate, and distribution uniformity. If an active drive mechanism is used, adjustments can be made dynamically based on sensor feedback. This ensures that grain is spread optimally even under varying load conditions, reducing the risk of uneven filling.

### FIG. 1.113—System Completes Operation and Resets for Next Load

Once the current grain load is fully distributed, the system either halts rotation (if passive) or enters standby mode (if active). If a new batch of grain enters, the process repeats automatically. The system may also perform self-checks for maintenance needs, alerting operators if bearing wear, roller misalignment, or blockages are detected.

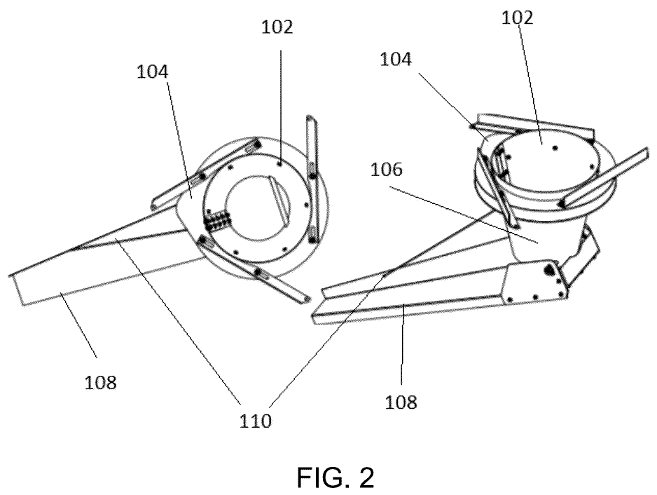

FIG. 2 presents two perspectives of the rotating grain spreader assembly, providing an overhead and sectional view of its structural and functional elements. The top-down view displays the full circular layout of the rotating grain distribution assembly (104), showing how the dispersal vanes (108) are arranged radially to ensure even grain distribution. The central support structure (102), which remains stationary, is positioned at the center, providing a mounting point for the entire system. Surrounding this structure is the rotational support mechanism (106), which may consist of an array of rollers or a slewing bearing, allowing controlled rotational movement.

The top-down profile view provides additional insight into the depth and height relationships of key components. This view shows the positioning of the inclined chute (110), which directs incoming grain toward the dispersal vanes. It also highlights the interface between the rotational support mechanism (106) and the rotating grain distribution assembly (104), showing how the spreader achieves smooth, continuous motion. If an active drive system is present, this view also indicates where the motor or drive mechanism is engaged with the rotating components.

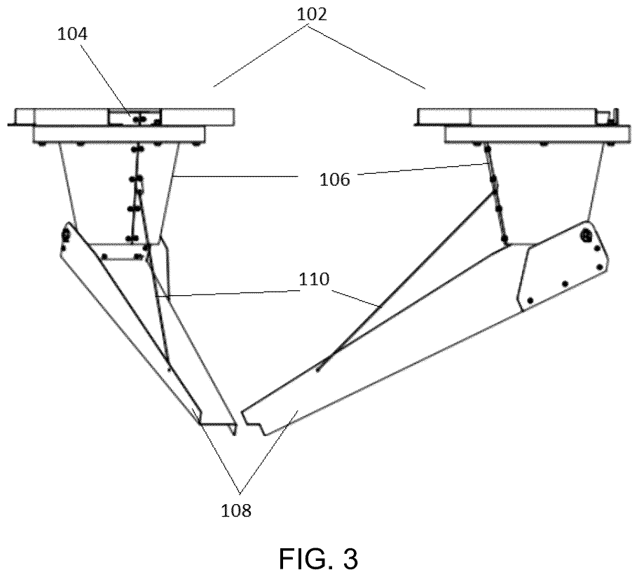

FIG. 3 presents a side cross-section and lateral perspective of the rotating grain spreader, further clarifying its internal structure and operational mechanics. The profile view depicts the inclined chute (110), which redirects grain from the inlet to the dispersal vanes at an optimized angle. This perspective highlights how the rotating grain distribution assembly (104) interacts with the rotational support mechanism (106), ensuring smooth rotation while maintaining stability. The dispersal vanes (108) are shown in detail, demonstrating their adjustable configuration to modify grain distribution patterns based on storage conditions.

The side view provides a lateral visualization of the spreader's installation and mounting within the silo. It clearly illustrates how the central support structure (102) is secured while allowing the rotating grain distribution assembly (104) to move freely. This view also depicts the mounting points for the rotational support mechanism (106), whether using an array of rollers or a slewing bearing, and how they engage with the rotating components. If a motorized drive system is included, this perspective shows the engagement of gears or other transmission elements that regulate rotational speed.

What is claimed is:

1. A grain spreader assembly for use in a storage silo, the grain spreader assembly comprising:
a. a central support structure configured to be mounted within the silo;
b. a rotating grain distribution assembly mounted on the central support structure, the rotating grain distribution assembly configured to receive incoming grain and distribute it in a uniform manner; and
c. a rotational support mechanism facilitating the rotation of the grain distribution assembly, the rotational support mechanism comprising at least one of:
i. an array of rollers positioned circumferentially around the central support
structure and engaging a circular track of the rotating grain distribution assembly, or
ii. a slewing bearing comprising an inner race fixed to the central support structure and an outer race connected to the rotating grain distribution assembly.

2. The grain spreader assembly of claim 1, wherein the array of rollers is constructed from a high-durability material selected from the group consisting of hardened steel and polymer composites.

3. The grain spreader assembly of claim 1, wherein the slewing bearing comprises a plurality of rolling elements positioned between the inner and outer races to facilitate low-friction rotation.

4. The grain spreader assembly of claim 1, further comprising a grain distribution hopper positioned to receive incoming grain and direct it toward the rotating grain distribution assembly.

5. The grain spreader assembly of claim 4, wherein the rotating grain distribution assembly comprises a plurality of dispersal vanes configured to guide grain outward in a controlled manner.

6. The grain spreader assembly of claim 1, wherein the rotation of the grain distribution assembly is driven by passive means, wherein the flow of incoming grain provides the necessary momentum to initiate and sustain rotational motion.

7. The grain spreader assembly of claim 1, wherein the rotation of the grain distribution assembly is driven by an active drive mechanism selected from the group consisting of an electric motor, a hydraulic actuator, and a mechanical drive system.

8. The grain spreader assembly of claim 7, wherein the active drive mechanism is coupled to the rotating grain distribution assembly via a geared interface or a direct drive connection.

9. The grain spreader assembly of claim 1, further comprising adjustable deflectors or vanes configured to modify the distribution pattern of the grain.

10. The grain spreader assembly of claim 1, wherein the grain spreader assembly is fabricated from a corrosion-resistant material selected from the group consisting of galvanized steel, stainless steel, and powder-coated aluminum.

11. The grain spreader assembly of claim 1, further comprising at least one sensor configured to monitor a parameter selected from the group consisting of rotation speed, grain flow rate, and distribution uniformity.

12. The grain spreader assembly of claim 11, further comprising a control system configured to receive data from the at least one sensor and adjust the rotational speed of the rotating grain distribution assembly based on the detected grain flow characteristics.

13. The grain spreader assembly of claim 1, wherein the rotational support mechanism is modular, allowing interchangeability between the array of rollers and the slewing bearing.

14. The grain spreader assembly of claim 1, wherein the array of rollers is mounted on fixed support brackets and engages a circular raceway integrated into the rotating grain distribution assembly.

15. The grain spreader assembly of claim 1, wherein the grain spreader assembly is configured for installation in silos of varying diameters and capacities.

16. The grain spreader assembly of claim 1, wherein the grain spreader assembly reduces grain segregation and compaction by achieving an even distribution pattern across the silo floor.

17. The grain spreader assembly of claim 1, further comprising a predictive maintenance system configured to monitor wear on the rollers or slewing bearing and provide maintenance alerts.

18. The grain spreader assembly of claim 1, wherein the rotational speed of the rotating grain distribution assembly is adjustable to accommodate different grain types and flow rates.

19. The grain spreader assembly of claim 1, wherein the rotating grain distribution assembly is configured to rotate at a speed between 10 and 40 RPM, the speed being adjustable based on grain flow rate, bin size, and grain type to optimize distribution and minimize particle segregation.

20. The grain spreader assembly of claim 1, further comprising trap doors, splash boards, or wear-resistant linings, wherein the trap doors are manually or automatically adjustable to modify the spread pattern, the splash boards are configured to deflect grain for enhanced distribution uniformity, and the wear-resistant linings are selected from the group consisting of urethane, ceramic, or other abrasion-resistant materials to reduce wear and extend component lifespan when handling abrasive grains.
